(19) United States
(12) Patent Application Publication
(10) Pub. No.: US 2019/0089825 A1
(43) Pub. Date: Mar. 21, 2019

(54) Built-In Mobile Device Voice Messaging System

(71) Applicant: Daniel E. Scott, Taylorsville, UT (US)

(72) Inventor: Daniel E. Scott, Taylorsville, UT (US)

(21) Appl. No.: 16/198,743

(22) Filed: Nov. 21, 2018

Related U.S. Application Data
(63) Continuation-in-part of application No. 14/924,506, filed on Oct. 27, 2015, now abandoned.

(51) Int. Cl. H04M 1/725; H04L 12/58; H04M 3/533; H04W 4/12

(52) U.S. Cl. CPC H04M 1/7255; H04L 51/24; H04W 4/16; H04M 3/533; H04W 4/12; H04L 51/10

(57) ABSTRACT

Systems, methods, and computer hardware, software, and/or media provide voice messaging systems operating on mobile electronic devices. The voice messaging systems provide voice messaging capability without relying on initiation of a telephone call by the mobile electronic device, and further provide video playback greetings to the user of the electronic mobile device that are controlled by the user recording and sending the voice message rather than by the recipient. Implementations of the invention further provide video playback greetings that are controlled by the recipient of a telephone call but that are delivered to the calling mobile electronic device while the telephone call continues

### CROSS-REFERENCE TO RELATED APPLICATIONS

This application is a continuation-in-part of prior application Ser. No. 14/924,506, filed Oct. 27, 2015, which is incorporated herein by reference.

### BACKGROUND OF THE INVENTION

### 1. Field of the Invention

The present invention relates to mobile devices having phoning capabilities, and more particularly to a voice messaging system for such mobile devices.

### 2. Background and Related Art

There are a variety of mobile devices having phoning capabilities in use today, including but not necessarily limited to smart phones, some tablet computers, and standard cell phones. While the capabilities of such devices has been growing over time, such devices continue to be limited in certain regards, especially in the ways in which such devices are able to handle communications between users.

### BRIEF SUMMARY OF THE INVENTION

Implementations of the invention provide systems, methods, and computer hardware, software, and media to provide voice messaging systems operating on mobile electronic devices. The voice messaging systems provide voice messaging capability without relying on initiation of a telephone call by the mobile electronic device, and further provide video playback greetings to the user of the electronic mobile device that are controlled by the user recording and sending the voice message rather than by the recipient. Implementations of the invention further provide video playback greetings that are controlled by the recipient of a telephone call but that are delivered to the calling mobile electronic device while the telephone call continues

According to certain implementations of the invention, a voice messaging system operates on a mobile electronic device. The voice messaging system may include software, hardware, or a combination of software and hardware. The system may be configured to receive a command input via hardware of the mobile electronic device indicating an intention to begin a voice message directed to a contact and to identify a video playback greeting associated with the contact and stored on a storage medium of the mobile electronic device. The system may also be configured to access and play the video playback greeting using a screen and speaker of the mobile electronic device, and to use a microphone of the mobile electronic device to record a voice message directed to the contact. The system then sends the voice message to a recipient device without initiating a telephone call with the mobile electronic device.

The voice messaging system may start, record, and send the voice message using as few as two command inputs to the mobile electronic device. For example, the two command inputs may include a first command input identifying the contact to receive the voice message and a second command input indicating that recording of the voice message is complete. The command inputs may include a touch input received via a touchscreen of the mobile electronic device or a voice command received via a microphone of the mobile electronic device.

The system may also be configured to receive an input governing handling of the recorded voicemail. The input governing handling of the recorded voicemail may include inputs such as instructions relating to timing of delivery of the voice message, instructions limiting access to the voice message, instructions relating to automatic deletion of the voice message, instructions relating to an attachment to accompany the voice message, instructions relating to sharing of the voice message, and instructions relating to playback of the voice message. For example, the system may be configured to automatically delete a received voice message immediately after the received voice message is played.

The voice messaging system may be adapted to transmit outgoing voice messages over a data network without initiating a telephone call from the mobile electronic device. The voice messaging system may also be adapted to receive incoming voice messages from a data network without initiating or receiving a telephone call from or to the mobile electronic device. The voice messaging system may be adapted to store received voice messages locally on a storage medium of the mobile electronic device. The voice messaging system may further be adapted to play back received voice messages stored on the storage medium of the mobile electronic device regardless of whether the mobile electronic device has a network connection at the time of playback of the received voice messages. The voice messaging system may also be adapted to record the voice message regardless of whether the mobile electronic device has an available network connection at the time of recording of the voice message. The voice messaging system may then be configured to transmit the voice message to a recipient when a network connection becomes available and to store the voice message at least until the network connection becomes available.

The voice messaging system may be configured to continue storing the voice message on the storage medium of the mobile electronic device even after the voice message is transmitted to the recipient. The voice messaging system may be adapted to receive an input from a user of the mobile electronic device indicative of which video playback greetings to use with each of the user's contacts, and wherein the user of the mobile electronic device controls which video playback greetings are used by the voice messaging system on the mobile electronic device.

According to further implementations of the invention, a system receives video content delivered to a mobile electronic device of an incoming caller over a network during a telephone call of the mobile electronic device. The system may include software, hardware, or a combination of software and hardware. The system is configured to initiate a voice telephone call over the network, identify that the network and the mobile electronic device's connection to the network is capable of handling a return video feed while the telephone call continues, and deliver a video playback greeting related to the voice telephone call to the mobile electronic device over the network while maintaining the voice telephone call.

The network may include a Wi-Fi connection to the mobile electronic device. The mobile electronic device may determine that the network and the mobile electronic device's connection to the network is capable of handling the return video feed. Alternatively, a remote computer system may determine that the network and the mobile electronic device's connection to the network is capable of handling the return video feed. The system may concurrently display an anticipated wait time to a user of the mobile electronic device using a screen of the mobile electronic device.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer device for use with embodiments of the invention;

FIG. 2 shows a representative networked computer configuration for use with embodiments of the invention; and

FIGS. 3-24 show representative screen shots associated with embodiments of the voice messaging system operating on a representative mobile device.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems, methods, and computer hardware, software, and media to provide voice messaging systems operating on mobile electronic devices. The voice messaging systems provide voice messaging capability without relying on initiation of a telephone call by the mobile electronic device, and further provide video playback greetings to the user of the electronic mobile device that are controlled by the user recording and sending the voice message rather than by the recipient. Embodiments of the invention further provide video playback greetings that are controlled by the recipient of a telephone call but that are delivered to the calling mobile electronic device while the telephone call continues

According to certain embodiments of the invention, a voice messaging system operates on a mobile electronic device. The voice messaging system may include software, hardware, or a combination of software and hardware. The system may be configured to receive a command input via hardware of the mobile electronic device indicating an intention to begin a voice message directed to a contact and to identify a video playback greeting associated with the contact and stored on a storage medium of the mobile electronic device. The system may also be configured to access and play the video playback greeting using a screen and speaker of the mobile electronic device, and to use a microphone of the mobile electronic device to record a voice message directed to the contact. The system then sends the voice message to a recipient device without initiating a telephone call with the mobile electronic device.

The voice messaging system may start, record, and send the voice message using as few as two command inputs to the mobile electronic device. For example, the two command inputs may include a first command input identifying the contact to receive the voice message and a second command input indicating that recording of the voice message is complete. The command inputs may include a touch input received via a touchscreen of the mobile electronic device or a voice command received via a microphone of the mobile electronic device.

The system may also be configured to receive an input governing handling of the recorded voicemail. The input governing handling of the recorded voicemail may include inputs such as instructions relating to timing of delivery of the voice message, instructions limiting access to the voice message, instructions relating to automatic deletion of the voice message, instructions relating to an attachment to accompany the voice message, instructions relating to sharing of the voice message, and instructions relating to playback of the voice message. For example, the system may be configured to automatically delete a received voice message immediately after the received voice message is played.

The voice messaging system may be adapted to transmit outgoing voice messages over a data network without initiating a telephone call from the mobile electronic device. The voice messaging system may also be adapted to receive incoming voice messages from a data network without initiating or receiving a telephone call from or to the mobile electronic device. The voice messaging system may be adapted to store received voice messages locally on a storage medium of the mobile electronic device. The voice messaging system may further be adapted to play back received voice messages stored on the storage medium of the mobile electronic device regardless of whether the mobile electronic device has a network connection at the time of playback of the received voice messages. The voice messaging system may also be adapted to record the voice message regardless of whether the mobile electronic device has an available network connection at the time of recording of the voice message. The voice messaging system may then be configured to transmit the voice message to a recipient when a network connection becomes available and to store the voice message at least until the network connection becomes available.

The voice messaging system may be configured to continue storing the voice message on the storage medium of the mobile electronic device even after the voice message is transmitted to the recipient. The voice messaging system may be adapted to receive an input from a user of the mobile electronic device indicative of which video playback greetings to use with each of the user's contacts, and wherein the user of the mobile electronic device controls which video playback greetings are used by the voice messaging system on the mobile electronic device.

According to further embodiments of the invention, a system receives video content delivered to a mobile electronic device of an incoming caller over a network during a telephone call of the mobile electronic device. The system may include software, hardware, or a combination of software and hardware. The system is configured to initiate a voice telephone call over the network, identify that the network and the mobile electronic device's connection to the network is capable of handling a return video feed while the telephone call continues, and deliver a video playback greeting related to the voice telephone call to the mobile electronic device over the network while maintaining the voice telephone call.

The network may include a Wi-Fi connection to the mobile electronic device. The mobile electronic device may determine that the network and the mobile electronic device's connection to the network is capable of handling the return video feed. Alternatively, a remote computer system may determine that the network and the mobile electronic device's connection to the network is capable of handling the return video feed. The system may concurrently display an anticipated wait time to a user of the mobile electronic device using a screen of the mobile electronic device.

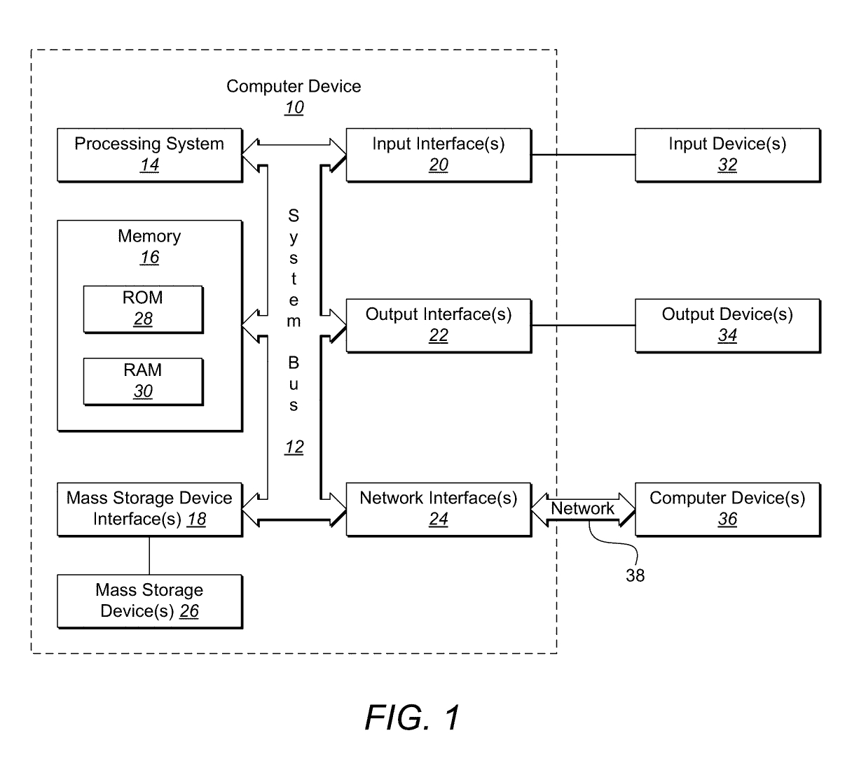

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, mobile devices capable of providing phone calls such as a mobile phone, a smart phone, a tablet computer, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include solid state drives, hard disk drives, magnetic disk drives, tape drives and optical disk drives. A mass storage device 26 may read from and/or write to a solid state memory, a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a touch screen, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network 38 may be or may include a cellular network. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

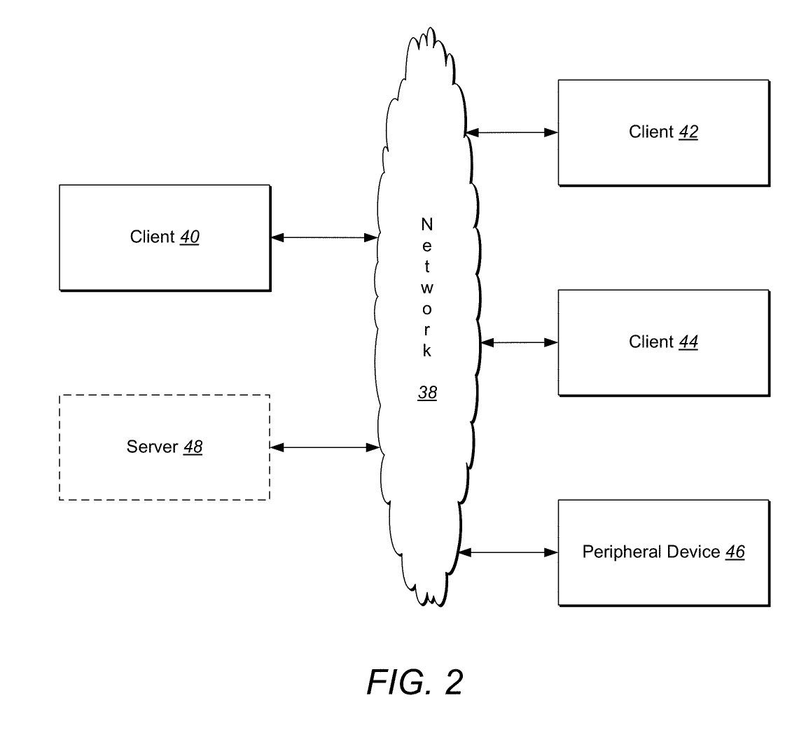

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

As mentioned previously, embodiments of the invention function in conjunction with mobile devices having phoning capabilities. Such devices include, but are not limited to cell phones, smart phones, tablet computers, and the like. Such devices may provide functionality as discussed herein through any combination of hardware and software. Such devices may also provide functionality as discussed herein through hardware and software contained essentially completely on the mobile device. Alternatively, some functionality may be provided in a distributed fashion using remote computing resources, where distribution of computing resources comports with the discussion provided herein.

According to embodiments of the invention, a voice messaging system is provided that serves to provide many of the functions discussed herein. The voice messaging system may be provided with any combination of hardware and software, and may be preinstalled on a mobile device, e.g., by the device manufacturer or a cellular provider. Alternatively, the voice messaging system may be installed on the mobile device subsequent to an initial sale of the mobile device. In instances where the voice messaging system is installed on the mobile device subsequent to an initial sale of the device, the voice messaging system may commonly be provided by software that uses existing hardware resources of the mobile device.

Thus, the voice messaging system may be provided as an application or app configured to operate with an operating system of the mobile device. A variety of voice messaging system apps may be provided to function with currently existing operating systems and with new operating systems in the future. Existing operating systems include Apple's iOS, Windows Phone, Bada, BlackBerry OS, Palm OS, Android, Symbian OS, and the like. The voice messaging system apps may be customized to best utilize mobile device resources of each device and operating system, and therefore there are a large variety of specific voice messaging system apps that may be provided in accordance with embodiments of the invention. In embodiments of the invention, the voice messaging system is installed on the mobile device and provides its functions on the mobile device.

The voice messaging system provides certain benefits over existing voice messaging and cellular call systems and methods while reducing loads on existing cellular voice networks. The voice messaging system provides an initial functionality and a user experience similar to existing voice messaging or cellular calling systems while relying an entirely new method for providing that functionality, and then also provides for a voice message exchange system that certain functions similar to a text message exchange system while augmenting the system by allowing for the exchange of communications nuances that can only be achieved with a system that captures and exchanges audible vocal expression. Additionally, the voice messaging system facilitates the exchange of information with and between people having handicaps or disabilities that otherwise struggle using existing communications methods and systems.

The voice messaging system provides users with a similar timing experience to existing voice messaging or cellular calling systems without requiring the initiation of a network-intensive telephone call over a cellular voice network provided by the cellular carrier. As such, the burden imposed on cellular networks may be greatly reduced. Additionally, because the voice messaging system does not utilize the voice network capabilities of the cellular network, but instead uses data storage capabilities on the mobile device itself to provide a similar experience, the user is able to experience a normal voice messaging experience even at times when the voice cellular network is unavailable. Furthermore, because the voice messaging system provides flexibility in handling voice messages, the user of the voice messaging system is able to experience incoming voice messages according to a varied schedule or desired user experience.

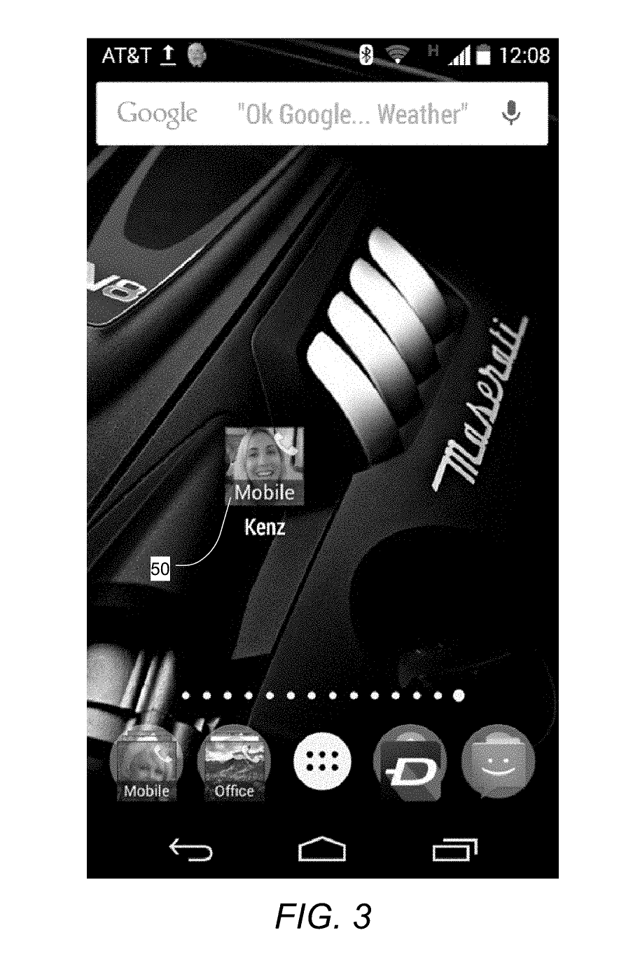

The voice messaging system provides the user experience through the mobile device by initially providing a user interface that may in many ways be similar to the user interface experienced using a traditional telephone calling system. Maintaining an interface and/or functionality similar to the functionality provided by existing telephoning systems may ease acceptance and use of the voice messaging system as it is adopted. This may be illustrated by reference to various Figures. According to existing telephoning and voice mail methods, a voice mail may be left by first initiating a telephone call over a network accessible to the mobile device, most commonly a cellular network, but increasingly may include a network accessed using Wi-Fi (e.g., a Wi-Fi call). FIGS. 3-5 illustrate illustrative steps performed when making a traditional voice call that results in a voice mail.

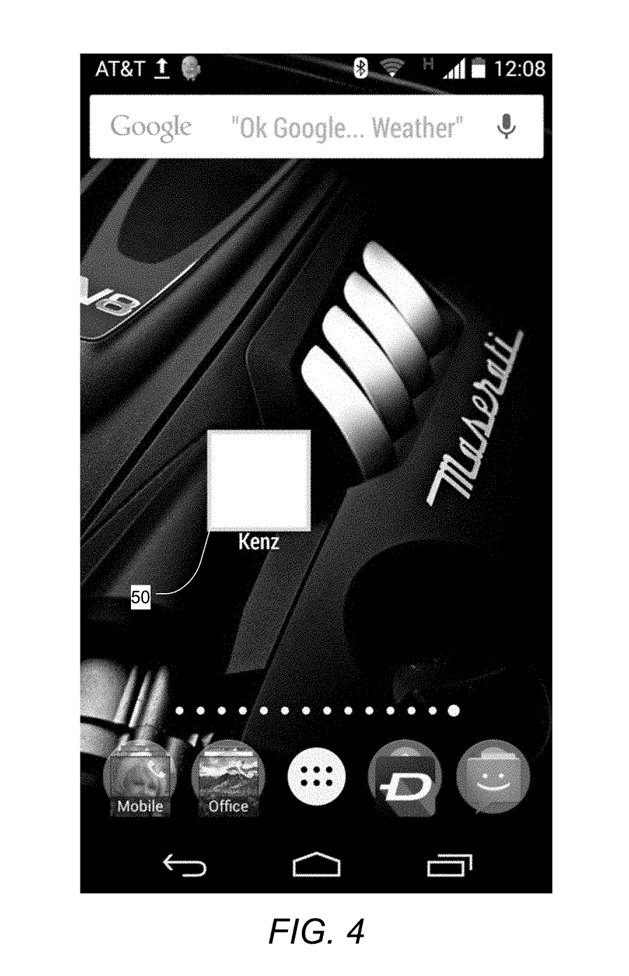

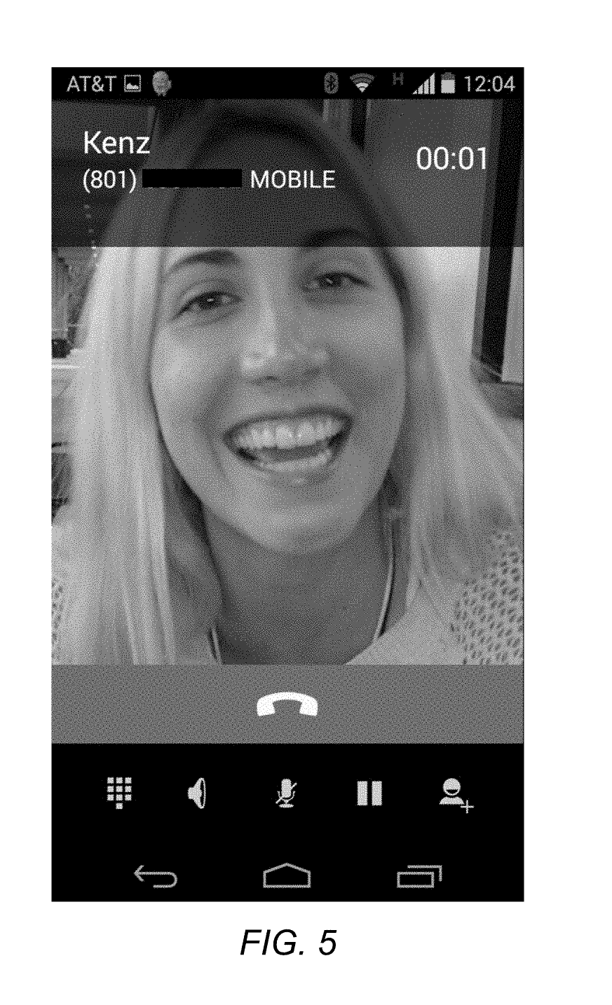

FIG. 3 shows a screen shot of a home screen that might be displayed on a mobile device such as a smart phone. As shown in FIG. 3, the user activates his or her mobile device (e.g. takes some sort of action to activate the screen) and uses some sort of link from the home page, contacts list, or some area to initiate a standard telephone call. In this example, the user might use a contact link 50 displayed on the home page, such as by touching the contact link 50, as illustrated in FIG. 4. (A similar effect could be achieved using any appropriate mechanism provided by existing smart phones or other devices, including voice-activated mechanisms, or any future-provided mechanism for initiating a voice telephone call using the mobile device.) Regardless of the manner in which the voice telephone call is initiated, today's mobile devices typically switch to a display that indicates to the user that a voice telephone call has been initiated, such as the display shown in FIG. 5.

The mobile device may show, as part of the display shown to the user, various status information associated with the initiated telephone call, such as status information showing the person and/or number called and indicating that the call is still active. The mobile device may also show controls associated with the call or mobile device available to the user, such as controls to activate a speakerphone function, to add additional callers, to display or activate numeric key functions, to mute the call, to discontinue the call or the like. Regardless of the display provided or not provided by the mobile device, the mobile device typically uses the device's network (e.g., cellular, Wi-Fi) to initiate a telephone call to a recipient's device.

According to current methods, when the mobile device attempts the telephone call, one of several things may occur. First, the mobile device' s attempt to initiate the call might be connected and the telephone call proceed as commonly understood. Second, the mobile device might be unable to reach its own network, whereupon the call is commonly terminated, as is also commonly understood. Finally, if the mobile device's network is available but the recipient is somehow unavailable, the caller is often provided with an opportunity to leave a voice message, which is commonly stored by the recipient's mobile network or occasionally by a voice message machine (e.g., for a landline). When the caller finishes leaving the message, he or she ends the message, such as by hanging up.

The recipient often receives some kind of notification of the waiting voice mail. The recipient then accesses the waiting voice mail by either dialing in to his or her voice mail provider and retrieving the message or by playing the message stored locally (e.g. on a local voice mail machine). Where the voice mail is stored by the recipient's cellular provider, the recipient typically is required to have access to the provider's systems, such as via the cellular network or a Wi-Fi network communicatively coupled to the cellular provider. Thus, if the recipient is unable to access the cellular provider systems, the recipient is unable to access his or her voice mail.

These steps illustrate certain disadvantages of existing systems and methods. First, the caller is unable to initiate a telephone call and/or voice message to the recipient unless the caller's mobile device is connected to a network capable of carrying a telephone call. This imposes limitations on the caller and when he or she is able to initiate the voice message. For example, when the caller's network is unavailable, the caller is unable to leave a voice message, and the caller might forget to call at a later time or might simply not have an opportunity to call at a later time when the network is available. Costs are also imposed on the service provider, as the provider is required not only to provide call-capable network resources to the caller, but to provide sufficient call-capable network resources at all times to all callers so as to be able to satisfy all possible potential calls at any moment or have callers suffer unwanted down time. Cellular service providers and other service providers incur significant costs in providing such network capability and availability.

Similar disadvantages are experienced by the recipient and his or her service provider. Even if the recipient had network coverage at the time the voice mail was originally left (e.g., was on another call or could not or did not take the original call for some other reason), the recipient's mobile device typically must be connected to a network capable of carrying a telephone call to access and retrieve the voice mail. If, for example, the recipient has now moved to a location where network access is unavailable or if the network is down or nonfunctioning, the recipient is typically unable to retrieve the voice message until a later time when the network is available. Furthermore, even when network access is available, the voice mail is typically retrieved by the recipient initiating a telephone call to the service provider's voicemail system, which imposes network burdens and costs on the recipient's service provider similar to those described above with respect to the original caller's service provider.

Embodiments of the invention provide advantages over existing systems while preserving traditional timing used by callers leaving voice messages. According to embodiments of the invention, a traditional telephone call using a voice-capable network (e.g., either a cellular voice network or a Wi-Fi voice-carrying network) is not needed either to leave a voice message or to retrieve a voice message. Instead, the voice messaging system utilizes data network capabilities of the mobile devices of the sender and the recipient to transmit voice messages. The voice messaging system thus incorporates the timing and data transmission advantages of text messaging (short message service and multimedia message service) while also preserving the ease of use, rapidity, and increased communication capability of traditional voice message systems.

According to embodiments of the invention, the process of creating and sending a voice message using the voice messaging system can be reduced to a process that only requires two mobile device selections from the user, namely, a selection to start recording of a voice message to a selected recipient and a selection to complete and send the voice message to the selected recipient. In this way, the functionality and experience of a normal telephone call that results in a voice message is essentially preserved: just as with a standard telephone call, the user takes an action or makes a selection to initiate a call/voice message, and when the voice message is complete, the user takes an action or makes a selection to terminate the call/voice message (e.g. hangs up). The difference is that no actual telephone call occurs, and the voice network resources of the cell phone service provider were never utilized.

Therefore, according to embodiments of the invention, the user makes the selection to start recording of the voice message, and may do so by an action similar to that traditionally used to initiate a mobile telephone call, such as by selecting a contact from a voice messaging app. Then, the user is prompted by the mobile device voice messaging system to record the voice message, records the voice message on the mobile device, and then makes the selection to end recording of the voice message, an action equivalent to hanging up on a traditional call, whether completed or after leaving a message on a carrier-based voice messaging system. All these steps can occur without the user ever making a telephone call or even without the user having any access to any kind of network. In other words, the user can decide to create a voice message and can record the voice message at any time when the mobile device is active, even when the mobile device is not in communication with a network and therefore cannot deliver the recorded voice message. The voice messaging system is able to record the voice message entirely locally using wholly local resources of the mobile device.

For example, the user may be prompted to begin recording a message using any resources of the mobile device, such as via a screen or other visual notification of the mobile device, via a speaker of the mobile device, and/or via a tactile component of the mobile device (e.g., a vibration motor). In one embodiment, the user is prompted to begin recording a message using a traditional beep similar to those commonly played by traditional voice messaging systems and played through a speaker of the mobile device. Similarly, the message is recorded using resources of the mobile device, such as using a microphone of the mobile device in conjunction with a storage medium of the mobile device to record and store the voice message. Once the voice message has been recorded and stored, the voice messaging system uses a network communication mechanism of the mobile device to access a network (when available) and to transmit the voice message to the recipient over the network. This typically occurs at or near the earliest moment at which the message sender's mobile device has reasonable network access, although uploading can be temporarily delayed if necessary to conserve network resources.

The recipient receives the voice message over the network when his or her mobile device is in communication with an applicable network (e.g., cellular, Wi-Fi, etc.) and downloads the message using non-voice-network resources. This typically occurs at or near the earliest moment at which the recipient's mobile device has reasonable network access, although downloading can be temporarily delayed if necessary to conserve network resources. After the voice message is downloaded, it is then stored locally and an applicable notification may be provided to the recipient using local resources of the mobile device. For example, the recipient may be notified of a received voice message using a screen or other visual notification of the mobile device, via a speaker of the mobile device, and/or via a tactile component of the mobile device (e.g., a vibration motor). Depending on the state and/or settings of the recipient's mobile device, the notification of receipt of the voice message may be postponed (e.g., until the state is changed), modified (e.g. a vibration notification only instead of a sound notification), or entirely omitted. Any delayed or modified notification may be modified, presented for the first time, or presented again once the recipient's mobile device is placed in a new state.

Because the received voice message is stored locally on the recipient's mobile device, the recipient need not access the voice message immediately. Additionally, the recipient need not have network access at the time when the recipient wishes to access the voice message. Instead, whenever the recipient wishes to access the voice message, the recipient uses the voice messaging system on his or her mobile device to access and play the voice message, which is played back from local memory using local resources (e.g., a local speaker of the mobile device).

The voice messaging system according to embodiments of the present invention, when operating on user's mobile devices, allows for the exchange of voice messages between the users regardless of whether a voice network connection is available to the users at the time of creating a voice message or at the time of consuming a voice message. Additionally, the system preserves many of the positive experience characteristics of current voice mail systems that do require a voice network connection on both the sending (at the time of creation) and receiving (at the time of consumption) ends, as well as many of the positive experience characteristics of current text or multimedia messaging systems. Such positive experience characteristics provided by embodiments of the voice messaging system include maintaining the timing and ease of creation of leaving a voice message through a two-step process, the maintaining of traditional actions for initiating and terminating a voice message, and providing access to on-demand creation and consumption of voice messages at any time, regardless of availability of voice network connections.

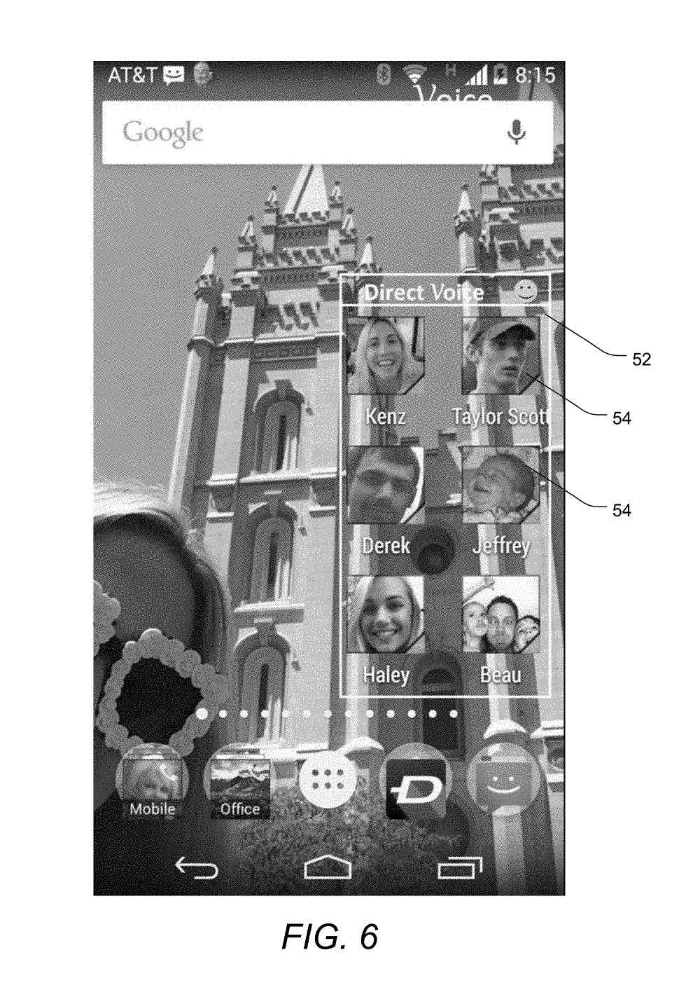

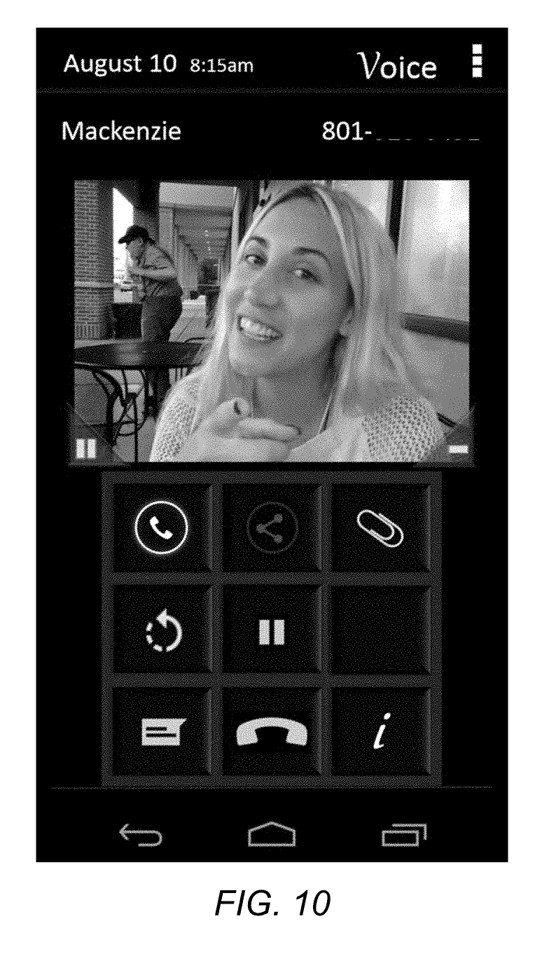

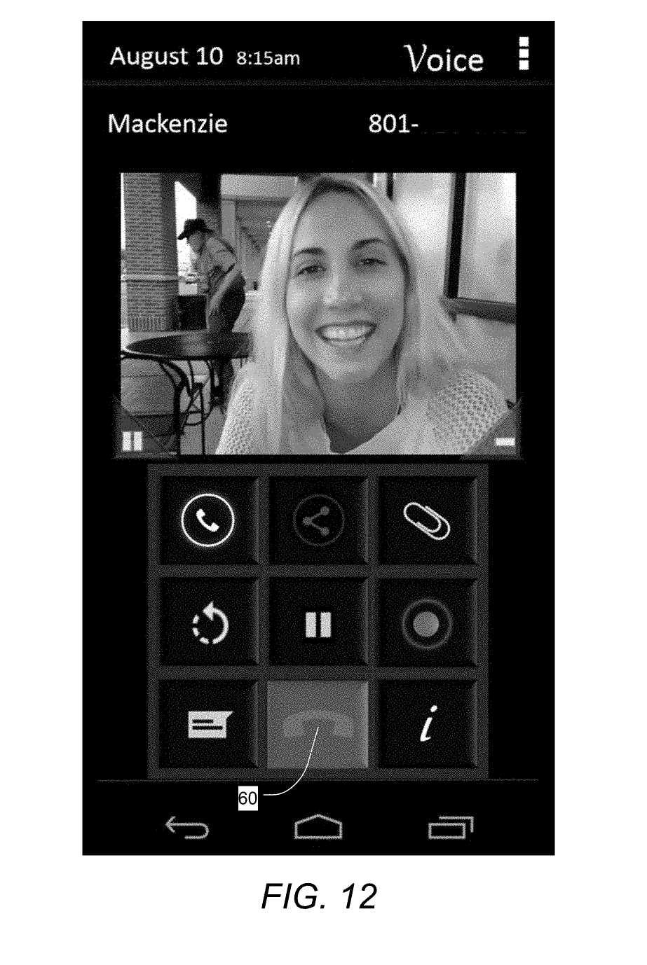

Additional advantages provided by the voice mail system may be appreciated through reference to an example of an embodiment of the invention, as illustrated in the accompanying Figures. The example may be made with reference to FIGS. 6-14. FIGS. 6-14 show screen shots of a display of a mobile device such as a smart phone, and are intended to be exemplary, not limiting, of embodiments of the invention. FIG. 6 shows a screenshot of an exemplary home screen that could be displayed on a mobile device. In this example, the voice messaging system provides a “Direct Voice” display 52 on the home screen. The display 52 shows various voice contacts 54 which may be selected by the user to initiate a voice message. In the illustrated embodiment, the voice contacts 54 are displayed with a user-selected name and image in a small tile. In other embodiments, the voice contacts 54 may be shown without images, with only images, or with any desired mechanism of allowing a user to select a contact to send a voice message.

The voice messaging system may provide any desired user interface that allows for the functionality discussed herein. Initially, the voice messaging system provides an interface that allows for the first step of selecting a voice contact 54 to receive the desired voice message. In the example shown in FIG. 6, that interface is the display 52 on the home screen with named picture tiles. As another example, the voice messaging system could provide an app interface that would not display voice contacts 54 on the home screen but instead would display voice contacts 54 on a dedicated app screen. As another example, the voice messaging system could utilize an sound-based interface, and could respond to a voice command such as “Direct Voice—Contact Name—.” Thus, the exact initial user interface provided by the voice messaging system is not limited to the specific example shown in FIG. 6.

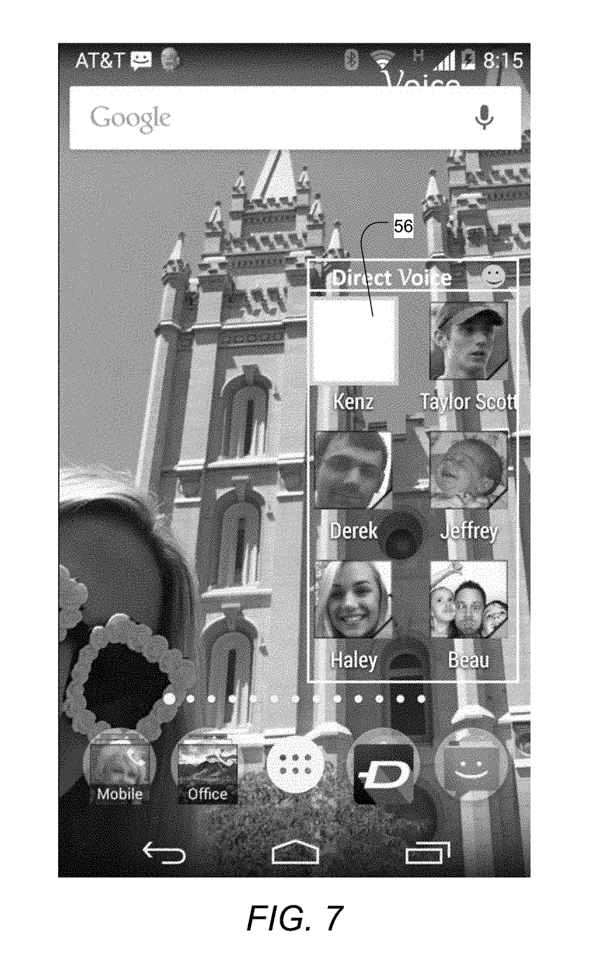

Regardless of the initial user interface provided, the user is provided an opportunity to take an action to select the intended recipient of the voice message. In some embodiments of the voice messaging system, this is the only action that is necessary to initiate the voice message: the only additional command interaction necessary will be the command interaction to stop recording and send the voice message. In the illustrated example, as shown by FIG. 7, the command interaction to start recording the voice message is the selection of one of the voice contacts 54 as a selected contact 56. Once the user has selected the chosen recipient, the voice messaging system may provide a user interface that confirms that selection and prompts the user to begin recording the voice message, such as by providing an audible beep.

In some embodiments of the voice message system, the user is provided with a type of prompt that differs from any prompt normally provided by voice message systems. In traditional voice message systems, namely those accessed across a traditional voice network and provided by the recipient's service provider or voice message machine, the recipient chooses the prompt that will be given to the incoming caller. Traditionally, the same prompt is given to all incoming callers, although more recently, some systems allow for the recording of different prompts such as prompts that differ when the recipient is on the phone as opposed to when the recipient does not answer for another reason. Traditional prompts are typically audio only, and include generic prompts such as “The person at phone number is not available, please leave a message,” or “Hello, you have reached John's cell, leave a message.” Thus existing systems are typically generic, are controlled by the recipient, and are limited to sound only.

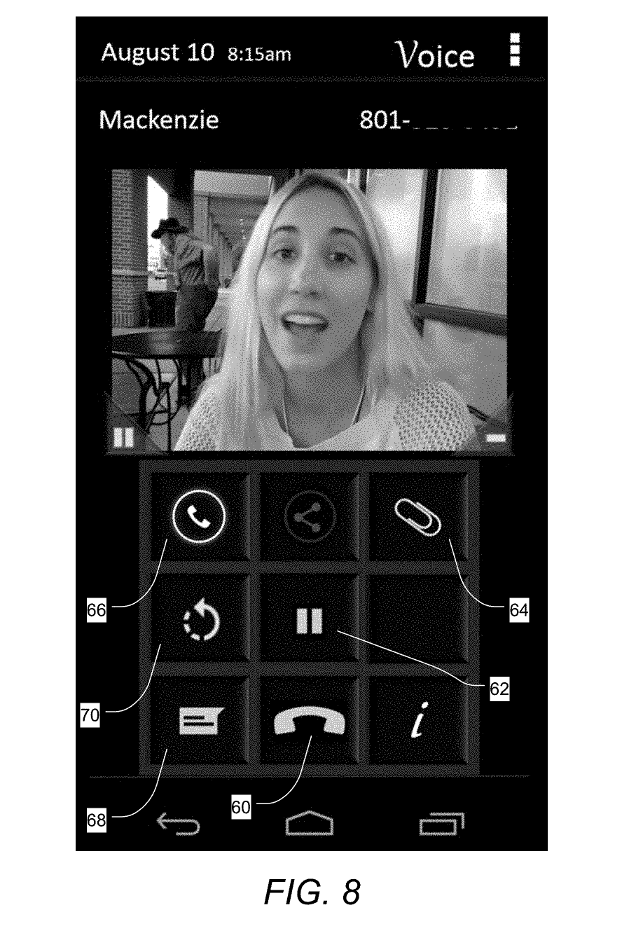

In contrast, embodiments of the invention utilize prompts to the creator of the voice message that may be customized in various ways to each individual recipient, that are controlled by the voice message creator, and that may include visual components such as pictures and videos. Accordingly, as illustrated in FIGS. 8-10, the voice messaging system may optionally display a video playback greeting to prompt the user to record the voice message. The video playback greeting may be displayed at any appropriate or desired size, and includes a video selected by the owner of the mobile device on the sending end. The video may include any video recorded by the sender's mobile device, or any other video received and accessible by the sender's mobile device.

For example, the sender of the voice message who wishes to use an embodiment of the voice messaging system might choose to record a video of the intended recipient using his or her mobile device for use by the voice messaging system. After recording the video, the user makes the video accessible to the voice messaging system, and the voice messaging system is thereafter able to use the video to prompt the user to begin recording the voice message. As may be appreciated, because the user records his own video for use with the system, there is no limit on the content of the video. Instead of traditional typically drab audio-only prompts to record voice messages, the user-chosen and recorded prompts may include any customized video and/or sound, such as “John you goofball, drop me a line,” or “Talk to me, baby,” or the like. Because the user has selected the prompt to begin recording the voice message, he or she knows exactly what to expect and when to begin recording, but also gets the pleasure of a reminder of a remembrance of the recipient or a typically fun moment or between him or herself and the recipient.

Additionally, because the video playback greeting is not limited to an audio-only greeting as with traditional voicemail systems, the video playback greeting is capable of conveying additional communication and meaning by way of the visual medium of communication. Indeed, a video playback greeting may be completely silent or may include sounds without any words. In face-to-face communications, significant portions of the communication may occur via non-verbal cues, and embodiments of the video playback greeting permit the capture and communication of such non-verbal communications that are lost with traditional audio-only greetings of traditional voicemail systems. For example, a video playback greeting might consist of a recording of a vacationer who films himself sitting while waiting for a small wave to reach his toes, conveying something along the lines of “I'm on vacation and it's great.” Another video playback greeting might show a child on a small skateboard ramp attempting and spectacularly failing a jump, conveying a message of “Look at what I just did—crazy, huh?” Still another video playback greeting might show a girl silently peering at the camera until a rose appears next to her face, causing her to smile and possibly silently mouth “Thank you,” conveying a message of “I loved the flowers you sent me.” The video playback greeting allows users of embodiments of the voice messaging system to break the boundaries of traditional audio-only systems to convey emotion and other non-worded communication. Indeed, embodiments of the voice messaging system permit video playback greetings to capture much of the as much as over 90% of communication that occurs via body language and other non-verbal communication.

Of course, the user is not limited to using a video recorded by his or her own mobile device. He or she could use any video or audio file as his or her prompt to begin recording a voice message for each contact. For one contact, the user might choose a short clip from a favorite shared movie. For another contact, the user might choose an audio-only file recorded at the device or otherwise. For another contact, the user might use a video recorded by that contact and sent to the user (e.g. via multimedia message, email, or the like) for purposes of use with the voice messaging system. For another contact, the user might use a silent video with no sound. For still another contact, the user might use a video with non-matching superimposed sound such as a favorite song. The possible choices are endless, and the selection of each is controlled by the sender through the voice messaging system operating on his or her own mobile device. In embodiments of the voice messaging system, the sender remains in control of the video playback greeting played by the system, even where the sender selects a video playback greeting provided by another person or device.

In fact, the user may store multiple prompts for one or more of his or her contacts. In one example, the voice messaging system might randomly choose from among the various prompts available for each contact. As another example, the voice message system might choose from among the various prompts depending on some timing consideration such as time of day, day of the week, weekday vs. weekend, or the like. As another example, the voice message system might choose from among the various available prompts based on a state of the user's mobile device, such as on, vibrate only, silent, connected to a data network capable of sending the voice message or not, or the like. As another example, the voice message system might choose from among the various available prompts based on a detected location of the mobile device. Indeed, any of a variety of considerations may be utilized by the voice messaging system, including preferences provided by the user to the voice messaging system.

By way of another example, the voice messaging system may select among the various available prompts for each contact based on some prior communication consideration, such as the length of time between the last interaction between the user and the selected contact. For example, if the sending user recently (e.g. within the last few minutes, within the last hour, or within some other selected or defined time) sent a message to the same contact, or if the sending user recently (e.g. within the last few minutes, within the last hour, or within some other selected or defined time) reviewed a voice message from that contact (and thus is apparently responding to that contact), the voice messaging system might select a different video playback greeting than might be selected if the user were sending a voice message to that contact with no prior recent interaction between them. At times, the provided prompt might be limited to a short beep, simply because the user or the voice messaging system recognizes that a longer prompt is unnecessary.

Regardless of what prompt the voice messaging system selects to give to the user, one distinct advantage of embodiments of the invention is the reduction or elimination of a time lag between the user's selection to send a voice message and the system's playing of the selected prompt. In traditional systems, the user's mobile device must first access the appropriate voice network, establish a connection with the user's mobile service provider, have a connection established to the recipient, and then have whatever necessary time elapses before the recipient's voice messaging device or service takes the call. Depending on the number of rings before the device or service takes the call, a significant amount of time may pass before the sending user receives a prompt to leave a voice message.

In contrast, because the voice messaging system of embodiments of the invention is operating entirely locally without any dependence on a voice network connection of the mobile device, the system can essentially immediately provide the necessary prompt and begin recording the voice message. Any delay in the ability to deliver the recorded voice message is not experienced by the sender, as the voice messaging system handles delivery in the background depending on available data network resources, whenever such resources are available. Similarly, the recipient avoids unnecessary delays when retrieving and playing a received voice message. Instead of having to dial in to a voice message retrieval system, dial in a password, and respond to other audible prompts, the recipient simply selects a voice message to listen to, and immediately playback begins.

Because the voice messages sent and received using embodiments of the voice messaging system are stored locally, the voice message system is able to provide advanced handling options for both the sender and the recipient. By way of example, a user might opt to retain and store his or her own sent voice messages, an option that is simply not available using existing systems and methods. In this way, the voice mail system could provide the user with the ability to readily verify what he or she said in the voice message and that the message was in fact sent to the recipient. The recipient could not say that no such message was sent. Similarly, the voice mail system provides numerous options for use and storage of received or sent voice messages. Because the messages are stored locally, they can be saved to external storage devices, shared with other users, emailed, edited, or used for any other applicable purpose, such as for one or more prompts in the voice messaging system. The voice messages are not subject to deletion by the service provider as with traditional voice mail systems, although the user may wish to provide some sort of backup protection against theft or loss of the device.

Optionally, a provider of the voice messaging system may maintain an online backup of voice messages passing through its system, such that upon loss, theft, or upgrade of a user's mobile device, the user is able to restore his or her received and/or sent messages to a new mobile device.

As another example of increased handling options, a user might opt to impose special handling restrictions on an outgoing voice message. For example, the sender might limit playback in some way, such as preventing playback in speakerphone mode. As another example, the sender might impose listing restrictions such as a restriction that the voice message be deleted after a single playback or after some other selected number of playback events or after the passage of a certain amount of time. As another example, the sender might be allowed to impose a password-style restriction to prevent playback of the voice message without input of the required password, pass code, gesture, or the like. In any of these examples, the sender might restrict the ability to forward, save, save externally, or modify the voice message. Thus, embodiments of the invention provide increased handling abilities in ways such as these to voice messages exchanged between users.

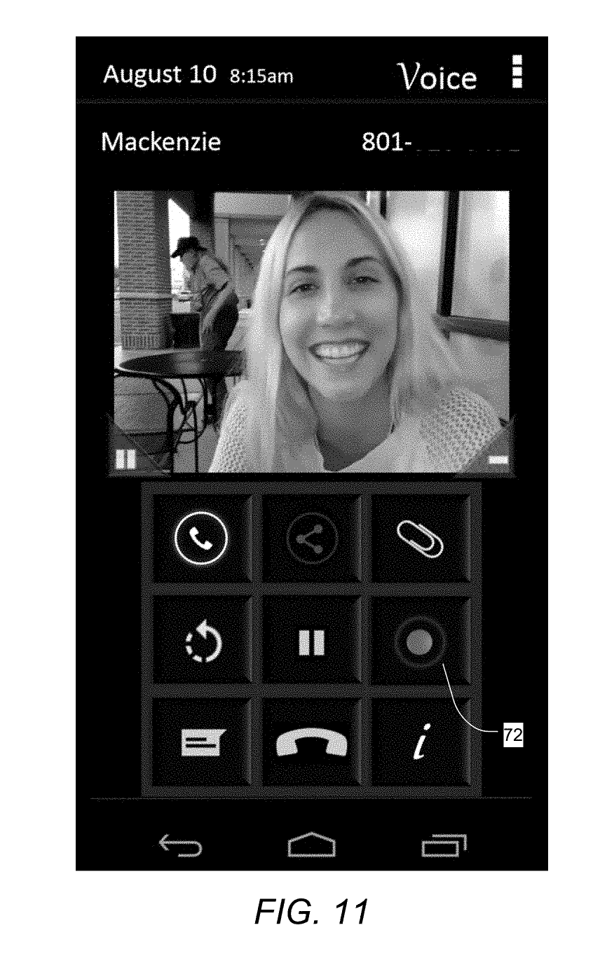

As discussed above, when a user selects a contact to initiate a voice message, the voice messaging system may display and play a video playback greeting as illustrated in FIGS. 8-10. The prompt to record a voice message (the video playback greeting) is not static, but the voice messaging system may display one or more static elements to the user. By way of example, and as illustrated in FIGS. 8-11, such static elements may include one or more notifications and/or controls. For example, the system may display a control 60 to abort or terminate the recording of the voice message, a control 62 to pause playback of the video playback greeting and/or recording of the voice message, a control 64 to allow attachment of a file to the voice message, a control 66 to interrupt the process and place a call to the contact, a control 68 to interrupt the process and initiate a text message to the contact, a control 70 to delete and re-record the voice message, and any other desired control or status notification. Indeed, as illustrated in FIG. 11, once recording of the voice message begins after termination of the video playback greeting or other prompt, a currently recording icon 72 may be illuminated to notify the user that recording is ongoing.

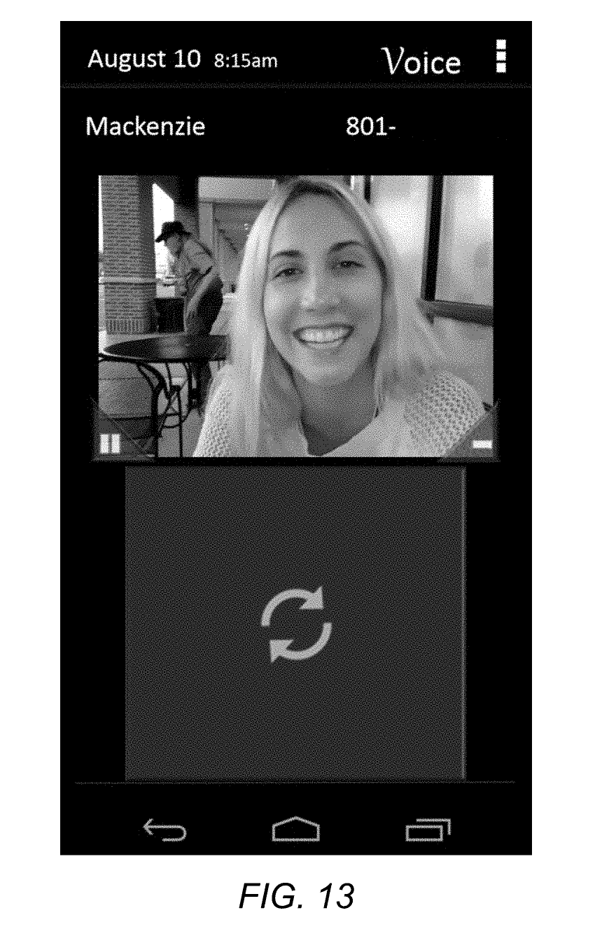

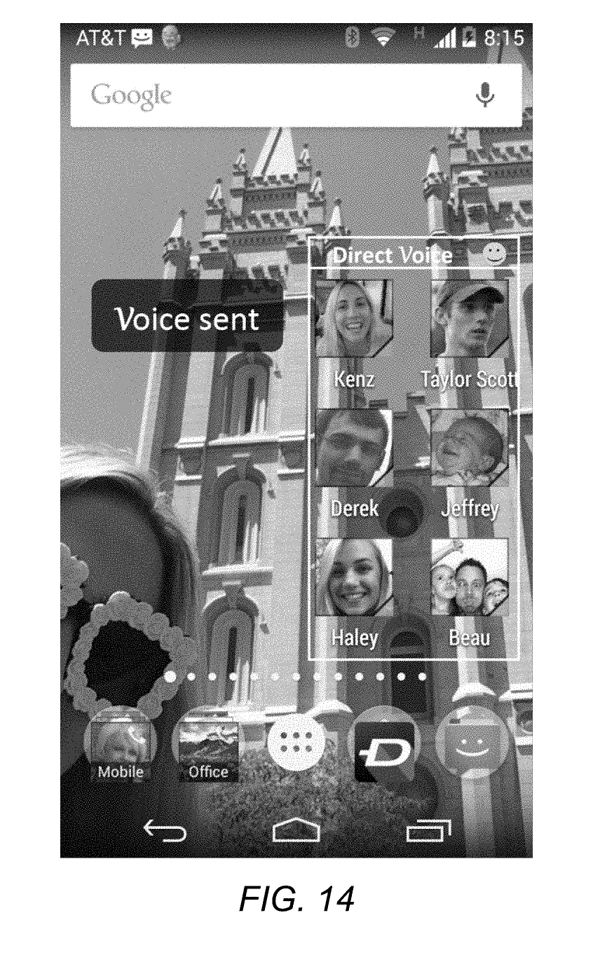

Once the user is done recording the voice message, he or she selects the control 60 to terminate the recording of the voice message, and the voice messaging system begins handling of the recorded voice message according to whatever rules and procedures have been established, as illustrated in FIG. 13. By way of example, the system may provide options to the sending user, such as selecting a time of delivery, imposing any restrictions such as discussed above, such as restrictions on playback, or any other desired options. By way of another example, the system might be configured to immediately deliver the message as soon as an appropriate data network connection is available. In some embodiments of the invention, where an appropriate network connection is available to the system while recording of the voice message is occurring, the voice messaging system may begin uploading the recorded voice message while recording is still ongoing. Regardless, the system may display an appropriate notification to the user when the voice message is sent from the mobile device, as illustrated in FIG. 14.

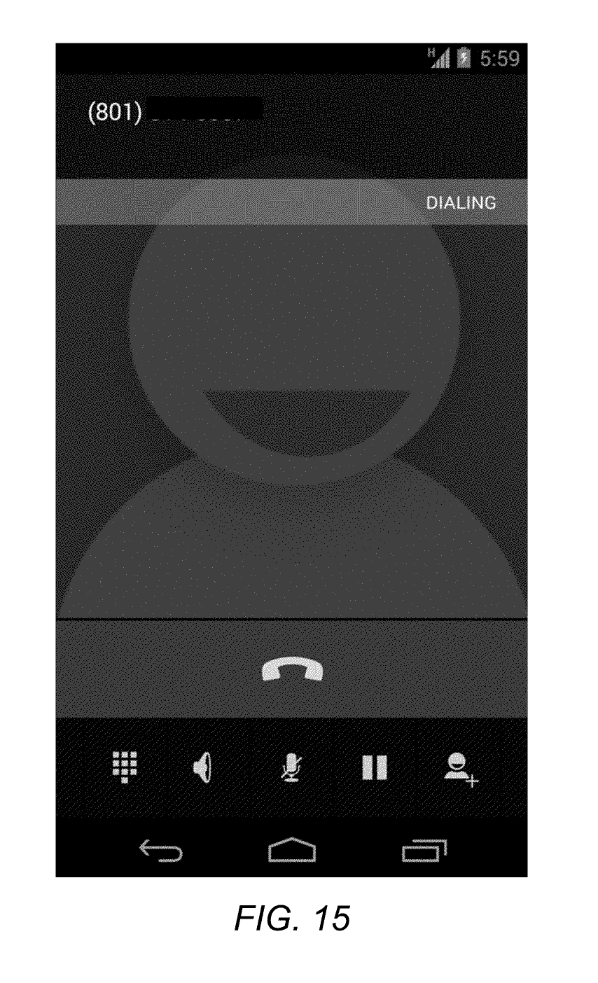

While video playback greetings as discussed above provide significant benefits to voice messaging systems as discussed above, their use need not be strictly limited to voice messaging systems. FIGS. 15-17 illustrate another way in which video playback greetings may be used according to embodiments of the invention. In this embodiment, a mobile device that initiates a voice call uses a data network to receive a video playback greeting for delivery to an incoming caller. For example, mobile calls using Wi-Fi are now available to some devices. As such devices are already using a data network to provide the voice call, certain call recipients may utilize the data network to deliver a video playback greeting to the incoming caller.

For example, a business receiving a call may at times have a backlog of incoming callers, and may wish to notify new callers of the expected wait time, and may also wish to provide an improved experience to the callers while they wait. A video playback greeting serves both needs. As illustrated in FIG. 15, a call may be initiated by a user using his or her mobile device according to traditional methods. However, once the call is connected, the recipient may detect or determine that the incoming caller has a connection with a capability to receive a video playback greeting. Therefore, instead of the incoming caller having only a status screen that indicates that the call is connected and possibly for how long the call has been connected, the call recipient is able to provide a video playback greeting with significantly more information provided to the incoming caller.

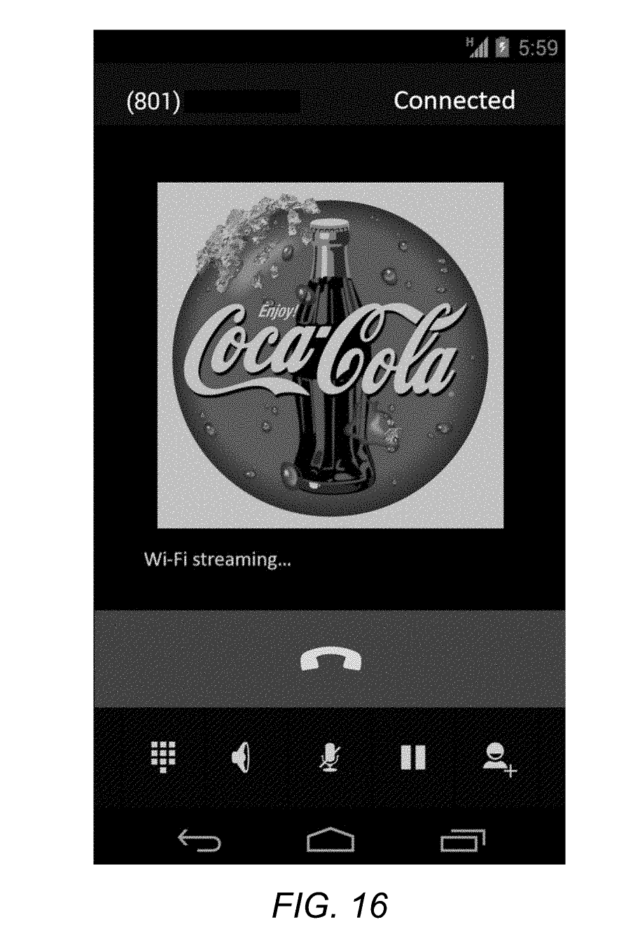

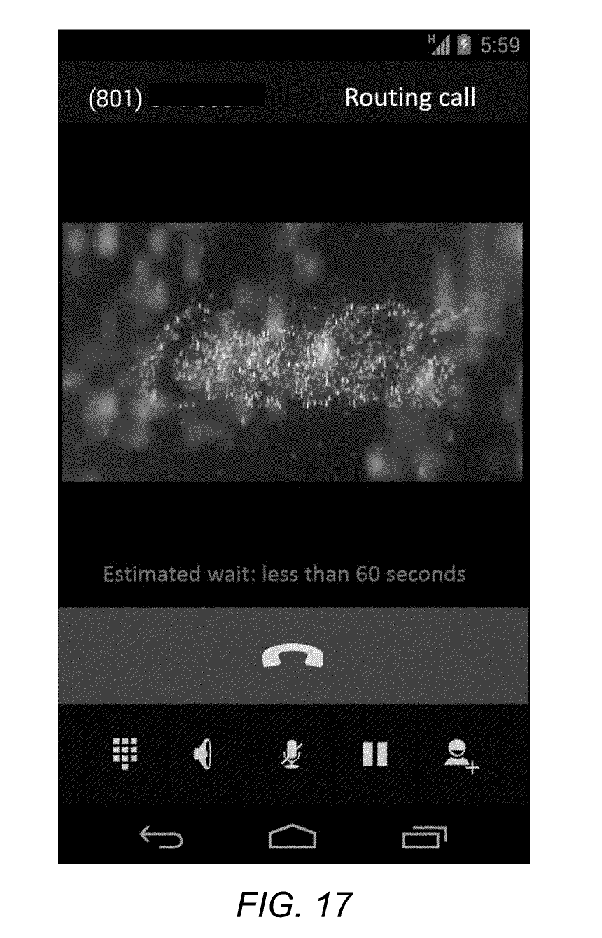

Initially, the caller might still receive audible notification that representatives are busy, as with traditional system. In contrast, however, a video playback greeting may be provided as illustrated in FIGS. 16-17. The video playback greeting may include a video commercial for the business, current news or other items of interest to the incoming caller, or any other desirable information. As one particularly relevant example, the video playback greeting may include displaying information to the incoming caller relating to his or her queue position and/or how long the expected remaining wait will be. It is anticipated that providing video playback greetings will provide a significant benefit to waiting callers, and will increase customer satisfaction overall.

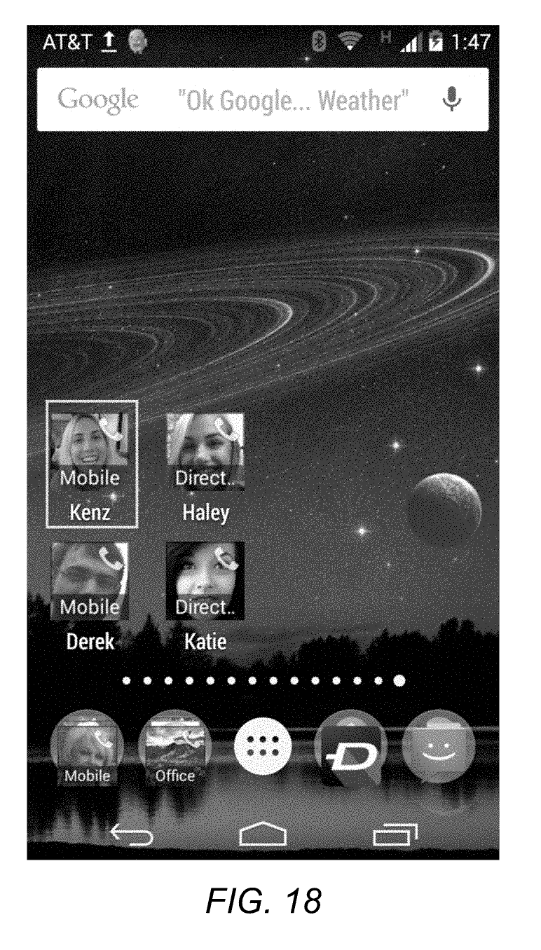

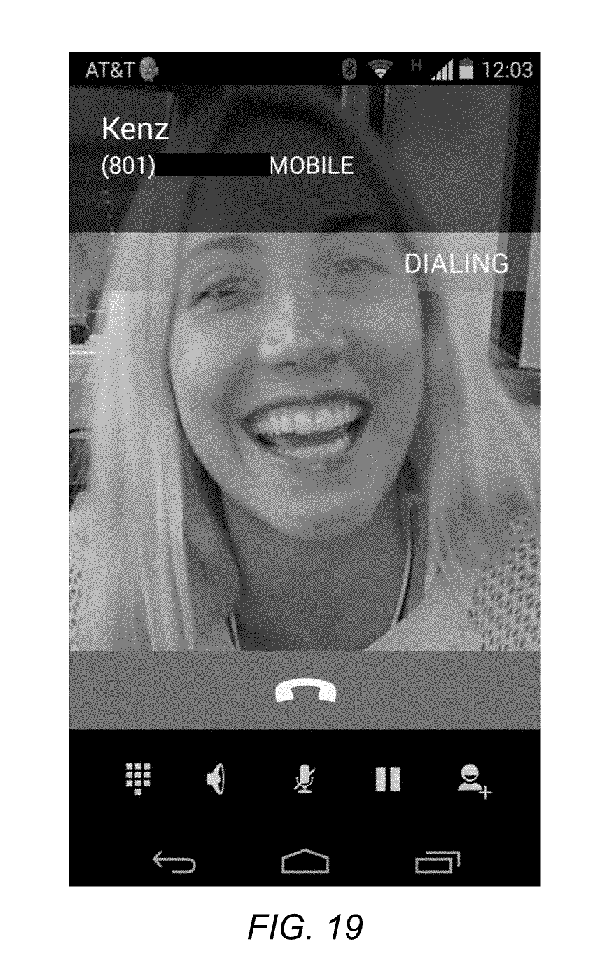

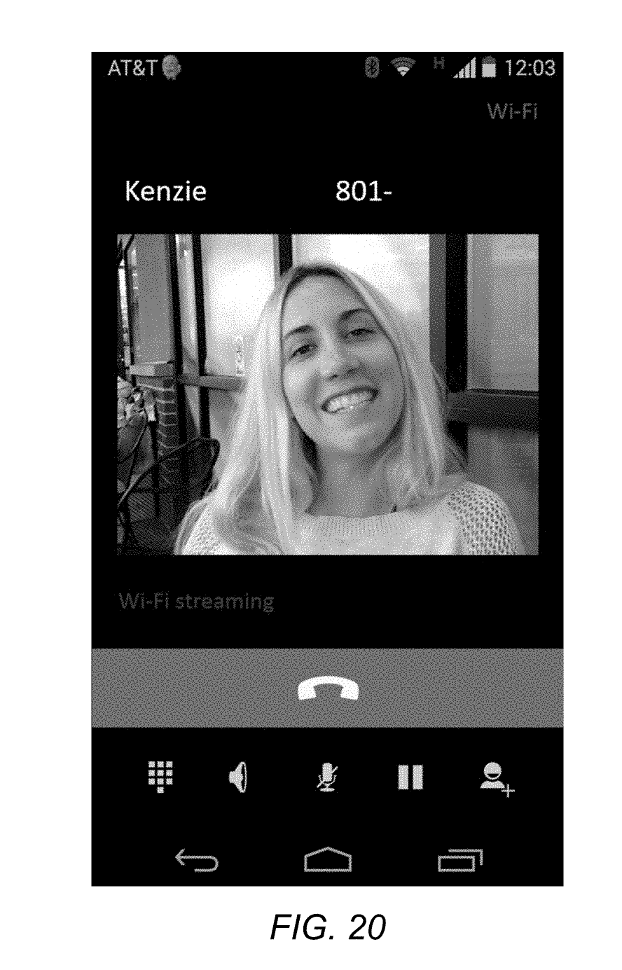

As another example, at times, video playback greetings may be provided by and controlled by a recipient's Wi-Fi service providers as part of a voice messaging service, as illustrated in FIGS. 18-20. A caller initiates a call as with traditional methods (FIG. 18). After the call is connected (FIG. 19), the service may detect the caller ID information of the incoming call and may further detect that the incoming call is from a mobile device/carrier capable of receiving the video playback greeting as the notification to the incoming caller to leave a message. The service provider could then serve a video playback greeting to the incoming caller rather than a standard audio-only prompt to leave a voice mail (FIG. 20). Additionally, the video playback greeting delivered could be customized in numerous ways. The video playback greeting delivered could be selected based on the identity of the incoming caller, so as to present a personalized greeting to each known caller. The video playback greeting delivered could be selected based on a state of the recipient's mobile device (e.g. connected to network and rung but did not answer, as opposed to not available to the network), or any of a variety of other considerations.

In ways such as these, video playback greetings and the other innovations described herein may provide a significant improvement over current communications between mobile devices. Current communications mechanisms are often limited in their ability to communicate. For example, standard text messages are woefully inadequate at expressing nuanced meaning and ensuring clear understanding. The addition of emojis and other special characters does little to preserve the nuances of language and meaning that can be conveyed with vocal inflection in voice messages in accordance with embodiments of the invention. Additionally, traditional text messages are typically slow to create, requiring multiple actions and keystrokes, whereas embodiments of the invention facilitate communication with as few as two command interactions with the mobile device, and with rapid creation at speaking speeds that typically far exceed the typing speeds of text messages. Embodiments of the invention, however, provide for the preservation of past communications in a way similar to text messages that has never before been available on mobile devices using traditional voice mail systems. Thus, communications between mobile device users are greatly improved using implementations of the voice messaging system.

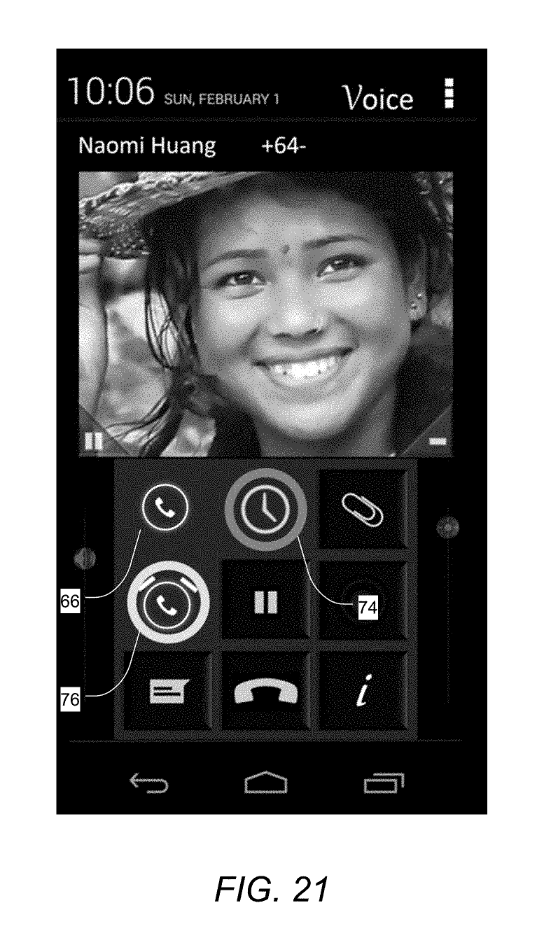

As discussed above, embodiments of the invention may provide a variety of call handling options. FIG. 21 illustrates one way of providing one type of option that may be provided using the control 66 to interrupt the voice message recording process. In this illustration, a prolonged selection of the control 66 (e.g., a press and hold action) might display two additional controls, a delayed send control 74 and a timed callback control 76. The user, after making the prolonged selection of the control 66 could then slide his or her finger to the desired additional control (control 74 or control 76) to make the additional selection. The delayed send control 66 could display options relating to timing of delivery or sending of the recorded voice message, as discussed above. Additionally, the delayed send control 66 could be used to cause delivery of a recorded voice message on any schedule desired by the sender, including minutes, hours, days, weeks, months, or years later, including any specific delivery time. Where delayed delivery is desired, the recorded voice message may be stored on the sending device, on a server provided by the service provider, or even hidden on the receiving device. The timed callback control 76 could be used to select a time to call the selected contact (either a set time such as 10:45 am, or a selected time delay from the present time (e.g., 30 minutes from now, sometime tomorrow), and could create a calendar reminder to call the selected contact.

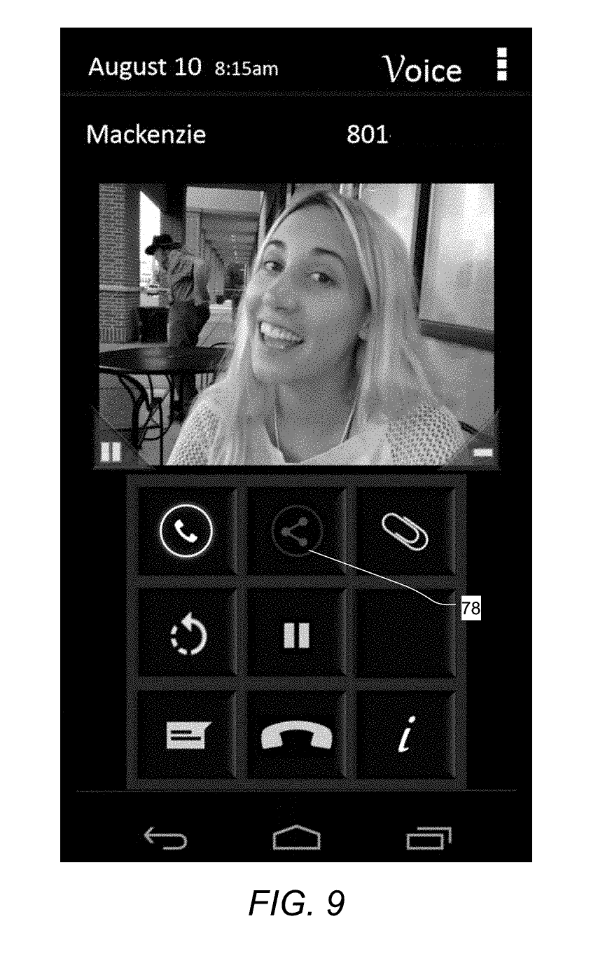

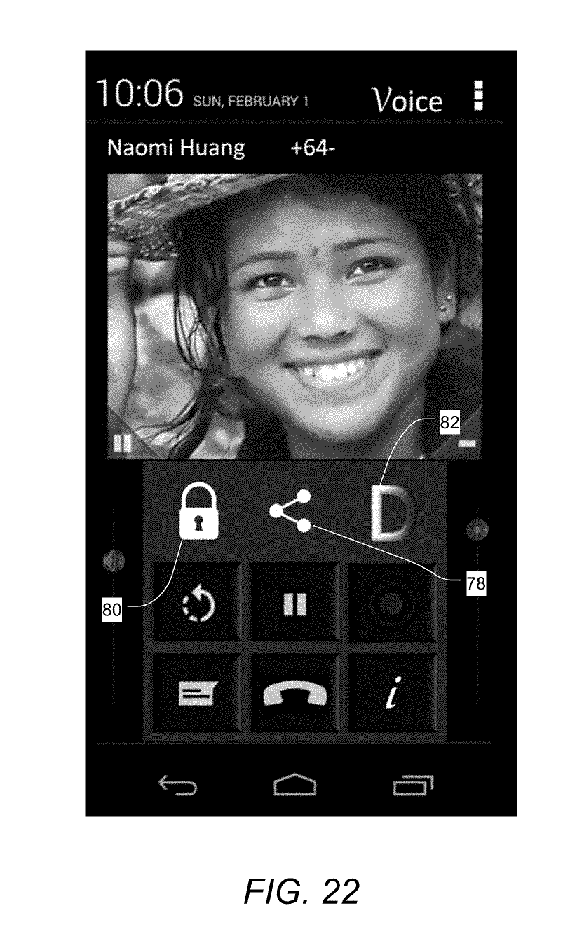

As another example, a prolonged selection of a control such as a sharing control 78 (see FIG. 9) might similarly display a row of three controls that might control the recipient's use of the created voice message. FIG. 22 illustrates this row of controls. The sharing control 78 might remain as a choice to permit free sharing by the recipient of the received voice message file. Selection of a locked control 80 might prevent the recipient from forwarding or otherwise sharing the received voice message file. Selection of a dissolving control 82 might allow the recipient to play the received voice message file a single time only, no pauses allowed during playback, followed by automatic deletion of the received voice message file from the recipient's mobile device, as discussed above. Other controls and options might be provided as desired. In some embodiments, when a selected setting is made, the setting might be preserved for that contact until a different selection is made. In other embodiments, the setting might revert to a default setting for the next recorded voice message. In still other embodiments, the setting might be preserved as long as the parties to a communication are responding to each other (e.g. within a certain time frame). In some embodiments, the user might be able to modify settings for all contacts at once. In ways such as these, embodiments of the invention provide increased handling options for the sender and the recipient of voice message files.

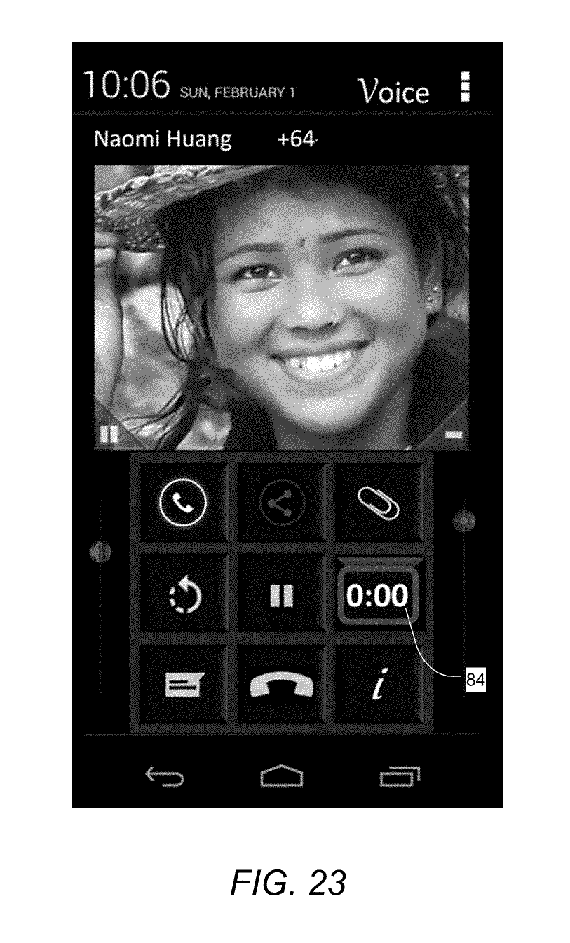

Another example of possible functionality of the voice messaging system is illustrated by FIG. 23. The user may select settings to allow the user to know how long the message being recorded has become. For example, the user might tap the currently recording icon 72, which could change the currently recording icon into an up timer 84, as shown in FIG. 23. The up timer 84 will show the length of the current recording, and tapping the up timer 84 again could return it to the currently recording icon 72 state. As with other settings, the choice could remain indefinitely or for a set time, could vary by contact, and/or could automatically reset as desired.

Another example of possible functionality of the voice messaging system relates to the functionality of the control 68 to interrupt the process and initiate a text message to the contact. In one example, when the control 68 is selected, the recording of the voice message is paused, and the user can create the text message, and when the text message is sent, the voice messaging system allows the user an opportunity to return to recording the voice message. Alternatively, selecting the control 68 might terminate and delete the recorded voice message. As another alternative, selecting the control 68 might terminate and send the recorded voice message as it then currently exists. As another example, a prolonged selection of the control 68 might provide additional controls from which to select such that the user could determine which of the foregoing options or other options will be taken.

As another example of handling of voice messages created and sent using the voice messaging system, certain embodiments may allow for selective automatic playing of received messages. For example, a user may instruct the voice messaging system on his or her mobile device to automatically and immediately play received messages from certain senders. Such a selection may be applied for a defined time period or indefinitely. By allowing for automatic and immediate playback, embodiments of the invention may provide for an experience that more nearly mirrors an actual telephone conversation between two contacts (e.g. the time lag between responses is minimized). Additionally, allowing for automatic and immediate playback may allow a recipient to be interrupted by anticipated urgent messages that require immediate responses. Further, allowing for automatic and immediate playback of messages from certain contacts may allow a user to prioritize responding to certain contacts: if an incoming message automatically plays, the user knows it is from among certain contacts, and if the incoming message does not automatically play, the user knows it must be from some other contact.

The use of embodiments of the voice messaging system provide additional advantages over existing systems and methods. Because few command interactions are required with the user's mobile device, and because the exchanged communications are audio communications, embodiments of the invention provide improved user safety. While it is generally recognized that it may be unsafe to use mobile devices for creating or consuming communications (e.g., texting) while driving or even walking, the reality is that such uses continue almost unabated. Because embodiments of the voice messaging system require so little visual attention of the user, with minimal action necessary to start and stop recording and/or to start playback, much of the user's attention can be returned to the user's surroundings, improving safety of the user and of others.

Because voice messages are stored locally, users of the voice messaging system will be able to rapidly access past voice messages in a threaded sense. Users may be able to access their own sent and received messages at any time, and the voice messaging system may store the messages in a relational way that is simply impossible with current systems. Current systems are accessed remotely and only save messages based on time received. Thus, using current systems, a user might have to listen to portions and/or skip multiple messages to get to the message of interest, and often doesn't know which is the message of interest without listening to significant portions of each message. For this reason, most users don't save more than one or two past messages. In contrast, embodiments of the innovative voice messaging system allow users to instantly view a list of messages arranged by contact and then by order of receipt, allowing rapid access to the voice message of interest.

In some embodiments, the locally stored voice messages can be manually or automatically labeled with visual information regarding the contents of the voice messages. By way of example, voice recognition technology can be used to automatically label received voice messages with the first few words or phrases contained within the voice messages. In some embodiments, the automatic labelling only occurs when network access is available to permit remote computing (e.g., cloud) assistance with voice recognition of the first few words or phrases. In other embodiments, manual labelling is permitted, such as at or near a point in time when the voice message is listened to using the mobile device. The user can label the voice message with information that will assist the user in identifying the stored voice message for later re-listening.

As described previously, the sending of voice messages as described herein provides significant advantages to all users over traditional methods for sending voice recordings, and in particular, such advantages are of particular assistance to handicapped or disabled individuals in that the number of steps required for recording and sending voice messages is significantly reduced. As described herein, the number of steps required for creating and sending a voice message can be reduced to two actions: an action of selecting a contact to send a voice message to, which action may also automatically initiate recording of a voice message after providing a prompt to the user, and an action to terminate recording of the voice message, which action may also automatically initiate a process for sending the voice message to its recipient. This two-step voice message creation and sending process is significantly simpler than traditional texting programs, such as iOS Messenger, that requires a user to hold down a recording icon throughout a voice recording process, which may be difficult for some persons with disabilities or handicaps.

The two-step recording process described herein may be further facilitated with mobile-device-integrated artificial intelligence assistant (AIA) assistance. AIAs include programs such as Apple's Siri, Amazon's Alexa, Microsoft's Cortana, and Google's Assistant (activated by saying “Hey Google” or “Okay Google”). AIAs such as these permit any user to engage a voice message program with a single simple voice command such as “Siri, Voice-me to [recipient name],” whereupon the voice messaging app will be engaged to initiate recording of a voice message to the named recipient and will provide a prompt (e.g., a beep) to the user as discussed previously to notify the user to begin recording. When the user is finished recording the voice message, the user can initiate a completion command again using the AIA, such as “Siri, send voice.” (Further references or examples provided herein using “Siri” should be understood as being exemplary only, and that similar examples could be provided using other digital assistants or AIAs, including those mentioned herein or others currently existing or created in the future.)

As may be appreciated from the foregoing example, the use of a voice-activated AIA to initiate and complete/send a voice message may permit even persons with very limited mobility to create and send voice messages using mobile devices. Accordingly, embodiments of the invention permit persons with mobility limitations to participate in communicating in a way that is essentially unavailable using traditional text messaging systems and applications.

The voice message app facilitates easy use by handicapped and disabled persons in part because the voice message app is dedicated to providing voice messaging instead of providing ancillary voice recording features in an app dedicated to providing other services such as iOS Messenger or WhatsApp. The voice message app functions via simulated telephone call activity, whereby the actions necessary to create and send a voice message are essentially similar to the actions that would be traditionally taken to initiate, participate in, and then end a telephone conversation, namely, (1) select a contact and initiate a voice message (akin to selecting a contact and starting a phone call), (2) recording the voice message after the prompt (akin to participating in a telephone call, and more particularly akin to leaving a message after reaching voice mail of a traditional system), and (3) ending the voice message, which causes it to be sent (akin to hanging up). As is illustrated in the Figures, the actions may even be represented by traditional-looking icons (selection of a contact to initiate, and selection of control 60, which resembles a hang-up icon, to end/send) to facilitate ease of use and ready familiarity with users. Accordingly, a user who selects to create a voice message knows what will happen before the app even opens, and use becomes easy.

Like traditional call direct, selection of the voice contact 54 automatically launches the voice app, opens for use to a specific voice contact 54, loads the recording module and activates it, plays a beep signal or other notification to begin recording, and then records the voice message. Upon completion, the user taps the simulated hang-up key (or performs an equivalent function through the AIA), and the system completes the recording, sends the file, and exits the program. The user is returned to the main screen where the process began and/or the phone returns to the state it was in before the process began. Another benefit is the potential inclusion of senses other than sight to notify the user to begin recording the voice message (e.g. the beep or other audible signal, or a vibration or other tactile signal provided by the mobile device).

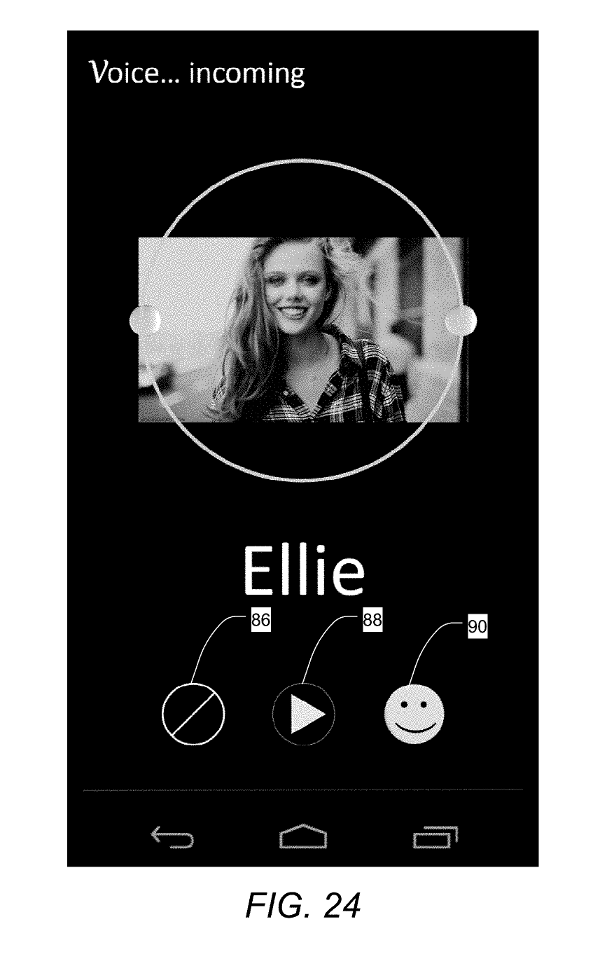

Simulated telephone call activity may be continued on the receiving end. According to certain embodiments of the invention, there are as many as four options for handling received voice messages. In a first mode, or “off” mode, a notice may be provided that a received file has occurred, whereby a notification may be placed in a mobile device indicator or notifications bar. In a second mode, or “on” mode, the voice message program or app may wake the mobile device (assuming it is in a sleep state) and may present the new voice message with a look much like the manner in which an incoming telephone call is displayed, as is illustrated in FIG. 24. If the incoming voice is left “unanswered” (not listened to) for a set period such as 10-15 seconds or for whatever time set by the user of the mobile device, then the simulated telephone call activity effect may end and a notification of the voice may simply be placed on the notifications bar.

During the simulated telephone call activity phase, when the incoming voice message is displayed in a fashion similar to an incoming call, the user may be presented with several controls to control handling of the incoming voice message. If the user selects control 86, the incoming voice message is ignored (for the time being), and a notification of the voice message passes to the notifications bar of the mobile device. If, instead, the user selects control 88, the user effectively “takes” the incoming voice message and is able to listen to it immediately upon receipt; the voice message begins playing. This again represents a continuation of the simulated telephone call activity, whereby a single action permits a user to effectively “answer” and listen to an incoming voice message as the user would answer an incoming telephone call. Finally, if the user selects control 90, he or she can change receiving modes for the voice messaging app or program.

The change of modes in response to an incoming voice message may be contact-specific, such that the user is able to change receiving modes for this particular contact at a glance. In particular, the user may be able to change a mode with respect to a particular contact to the “off” mode, where incoming voice messages do not wake the mobile device but are merely listed on the notification bar for future consumption. Alternatively, the user could activate a “conversation” mode, discussed below.

According to a third mode, or “auto-play” mode, automation of handling of the incoming voice message is increased. This mode may be similar to auto-answer modes that may be provided for incoming telephone calls, in that the voice messaging app or program automatically begins playback of all messages or of all messages from selected voice contacts in accordance with a user preference option, such as after a designated number of “rings” (again simulating telephone call activity) or after an allotted time has passed. The auto-play mode provides hands-free convenience to the user and provides the user with convenience of being able to automatically listen to incoming voice messages in situations where touching or handling the mobile device may not be desirable. The user may choose to stop auto-play within the allotted time, such as by selecting control 86 on a display similar to that of FIG. 24. The auto-play mode may also be particularly helpful for disabled or handicapped individuals, who need take no action at all to begin listening to received voice messages.

A fourth mode, or “conversation” mode, is not a general mode for the voice messaging system, app, or program, but is an overriding mode. While most modes may handle how all new voice message is handled, the conversation mode is activated for use on a single voice contact at a time. The conversation mode is particularly useful when the user wishes to enter into an exchange of voice messages with the voice contact, similar to holding a telephone conversation with slight delays between exchanging of voice messages (as the receiving end receives and listens to voice messages). During conversation mode, it is not necessary for both parties to be in the same conversation mode. One party might be in the conversation mode and the other in the on mode. The party in the conversation mode might be in that mode to facilitate ease of listening to and replying to voice messages. In the conversation mode, playback of incoming voice messages with the voice contact begins automatically upon receipt, and as playback of each voice message completes, the user is relatively immediately and automatically prompted to begin recording a reply voice message. The user can pause or stop playback or recording at any time, but this mode facilitates rapid responses as if the user were in a conversation with the voice contact.

In some embodiments, the user may be in the conversation mode with multiple voice contacts at once. The voice messaging program or app may selectively delay playback of incoming voice messages from one voice contact while the user is listening to or responding to voice messages from another contact. The inherent delays that occur as parties receive, listen to, and then respond to voice messages will generally allow multiple conversations to occur at the same time without significant additional delay.

The various modes may be suited for use in different situations. The “off” mode may be used during rest times or when the user is occupied, such as when he or she is in a meeting and does not want to be disturbed. The “on” mode may be used when the user is active and aware and willing to receive voice messages. The auto-play mode may be useful in situations where being hands-free is a priority. These modes may each affect the entire contacts list, although some embodiments embrace selection of modes on a contact-by-contact basis (e.g., a husband may wish to auto-play voice messages from his wife or child, but not those from other voice contacts, or a worker may wish to auto-play voice messages from a co-worker working on an important collaborative project, but not those from other voice contacts).

The AIAs provided with mobile devices may be integrated with the voice messaging program or app to varying degrees. According to some embodiments of the invention, the voice messaging app or program is allowed to run even while the mobile device is otherwise operating in a sleep state. In this fashion, the voice messaging app may allow a mobile device to remain attentive to AIA commands being presented to the mobile device. A distinguishing word such as “Voice” may be used to distinguish between commands for the voice messaging app or program and for those commands intended for the general use of the AIA. Thus, when a command begins such as “Siri, Voice . . . ,” the AIA recognizes the command as a command intended for the voice messaging app or program, and action on the command may be taken without waking the mobile device in response.

A vocal command may be used in the first instance to instruct the mobile device to begin running the voice messaging app and to keep it running even when the mobile device enters a sleep state. Such a command may be something like “Siri, run Voice.” When this command is active, the mobile device can be expected to be alert to commands to operate the voice messaging app or program even when the mobile device appears to be sleeping. This ability to be running, even when the mobile device is otherwise in a sleep state, may be particularly useful to handicapped or disabled persons, as they will be able to readily create voice messages without first having to wake or activate the mobile device, thereby simplifying the steps necessary to create and send voice messages.

When the voice messaging app or program is running on the generally sleeping mobile device, continued commands can be given without waking the mobile device. Commands may include commands such as “Siri, Voice-me to [contact name].” However, because the voice messaging program is operating on the mobile device, it can be used to access other features of the mobile device, such as by causing the mobile device to enter into an awake state with a command such as “Siri, Voice-awake my phone.” Thus, the voice messaging app or program can serve as a doorway to the full use of the AIA even when the mobile device is largely sleeping. Similar commands can be used to awaken only certain features, programs, or apps of the mobile device.

A variety of other program specific or general AIA commands could be provided as well. The foregoing commands are merely examples of commands that could be provided using the AIA access path through the running voice messaging program or app. By way of example, the command path may be used to activate a mobile device flashlight, a voice recorder application, to conduct a search of recorded voice messages, to conduct an outside search (e.g. through a search of the mobile device contents or conducting an Internet search using available network assets), to run or activate other programs or apps on the mobile device (e.g., a voice recorder), to play stored or received voice messages, to list new voice messages (e.g., from the notifications bar), to cause the mobile device to emit light, vibrations, or noises to permit localization of the mobile device, to input additional commands into running applications or programs (e.g., pause recording, stop recording, etc.), and to interact with ongoing voice messaging operations (e.g., pause (playback or recording), resume (playback or recording), redo (for recordings, allowing to begin over), play or play it (plays received voice message and/or plays recorded voice message for review prior to sending), change modes, enter conversation mode, and send it later (permits delayed delivery of voice messages as discussed herein).

In some embodiments, delayed sending of voice messages may be facilitated by storage of delayed-delivery voice messages by a centralized collection center or server that is remote to the mobile device. When a network connection is available to the centralized collection center or server, the mobile device sends the voice message to it with instructions for later delivery. Then, the centralized collection center or server provides for delivery in accordance with the delivery instructions. Instructions for delayed delivery may originally have been provided using the mobile device's AIA interface.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A voice messaging system operating on a mobile electronic device and adapted to facilitate handicapped transmission of voice messages using a two-step process similar to a two-step process for traditional mobile calling, the voice messaging system comprising:
one of software, hardware, and a combination of software and hardware configured to:
receive a first one-step command input from a user of the mobile electronic device via hardware of the mobile electronic device, the first one-step command input indicating an intention to begin a voice message directed to a contact;
generating a prompt to the user of the mobile electronic device indicative of a time to start recording the voice message;
using a microphone of the mobile electronic device to record a voice message directed to the contact;
receiving a second one-step command input from the user of the mobile electronic device via hardware of the mobile electronic device, the second one-step command input indicating an intention to end and send the voice message; and
sending the voice message to a recipient device without initiating a telephone call with the mobile electronic device.
